(19) United States
(12) Patent Application Publication
(10) Pub. No.: US 2016/0063542 A1
(43) Pub. Date: Mar. 3, 2016

(54) PROVIDING INFORMATION ASSOCIATED WITH A PRODUCT

(71) Applicant: Yahoo!, Inc., Sunnyvale, CA (US)

(72) Inventors: Varun Bhagwan, San Jose, CA (US); Suhas Sadanandan, Pleasanton, CA (US); Doug Sharp, San Francisco, CA (US); Derek Louie, Arcadia, CA (US); Kevin Day, San Jose, CA (US)

(21) Appl. No.: 14/470,813

(22) Filed: Aug. 27, 2014

(51) Int. Cl. G06Q 30/02

(52) U.S. Cl. CPC G06Q 30/0251; G06Q 30/0273

(57) ABSTRACT

As provided herein, information associated with a first product may be provided to a device using an identifier that corresponds to the device and that is received from a different device. For example, a selection associated with the first product may be received (e.g., by a server) from the different device. A request for the identifier may be provided (e.g., by the server) to the different device. The identifier may be received (e.g., by the server) from the different device, and information associated with the first product may be provided (e.g., by the server) to the second device using the identifier.

### BACKGROUND

Many users perform tasks through applications and/or websites. Such tasks may involve identifying products that may be of interest to users. Some products may be digital products that may be downloadable from a content source.

### SUMMARY

In accordance with the present disclosure, one or more systems and/or methods for providing information associated with a product are provided. A selection associated with a first product may be received from a first device. The first product may comprise an application, an audio file, a video file and/or a document. A request for an identifier corresponding to a second device may be provided to the first device responsive to the receiving a selection. For example, the identifier may comprise a phone number. The identifier may, for example, correspond to merely the second device, and may not correspond to one or more other devices. The identifier may be received from the first device.

Information associated with the first product may be provided to the second device using the identifier. For example, the information may be provided to the second device via a Short Message Service (SMS) message, an email message, a Multimedia Messaging Service (MMS) message and/or an instant message. In other examples, the information may not be provided to the second device via an instant message. The information may comprise a link. For example, the link may correspond to a location from which the first product is downloadable.

A selection associated with the information may be received from the second device. A type of the second device may be determined responsive to the receiving a selection associated with the information. For example, the type may correspond to an operating system associated with the second device. In another example, the type may correspond to a digital distribution platform associated with the second device. Second information may be provided to the second device based upon the type of the second device. For example, the second information may correspond to the digital distribution platform associated with the second device.

A charge for an advertiser associated with the first product may be determined responsive to the providing the information to the second device. Alternatively and/or additionally, the charge for the advertiser associated with the first product may be determined responsive to receiving the selection associated with the information from the second device. Alternatively and/or additionally, the charge for the advertiser associated with the first product may be determined responsive to receiving an indication that the first product has been downloaded by and/or installed on the second device.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method of providing information associated with a product.

FIG. 5 is a component block diagram illustrating an example system for providing information associated with a product.

FIG. 6A is a component block diagram illustrating an example system for providing information associated with a product.

FIG. 6B is a component block diagram illustrating an example system for providing information associated with a product.

FIG. 7 is a component block diagram illustrating an example system for providing information associated with a product.

FIG. 8 is a component block diagram illustrating an example system for providing information associated with a product.

FIG. 9 is an illustration of a scenario featuring an example nontransitory memory device in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

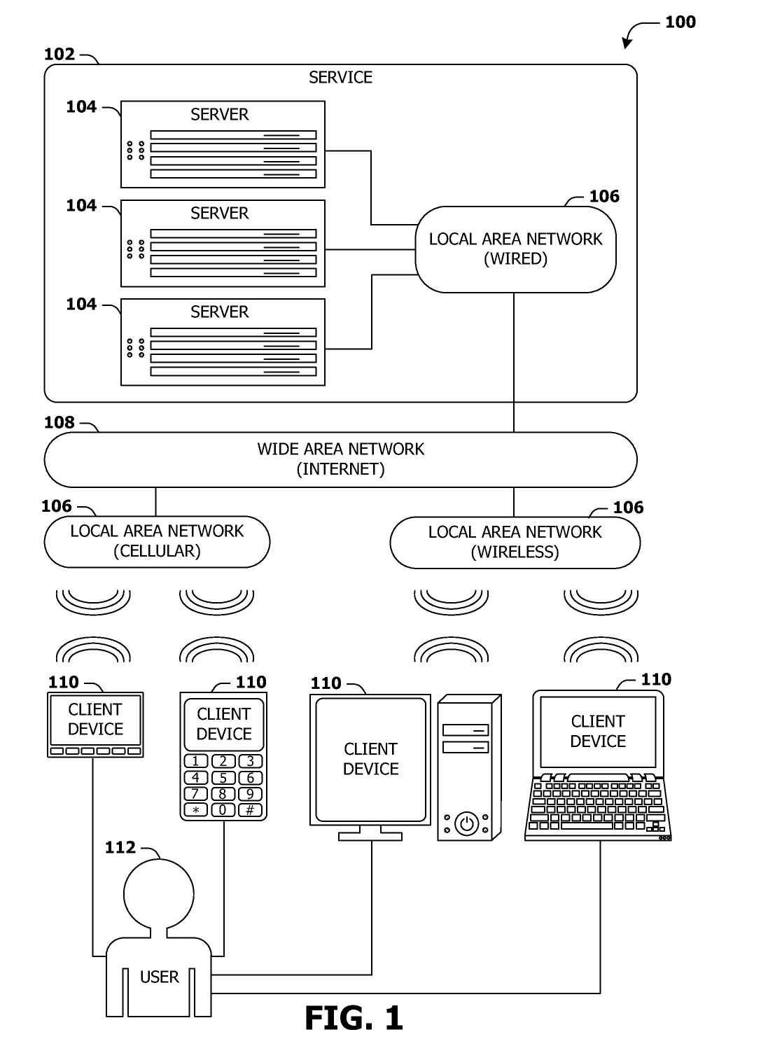

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

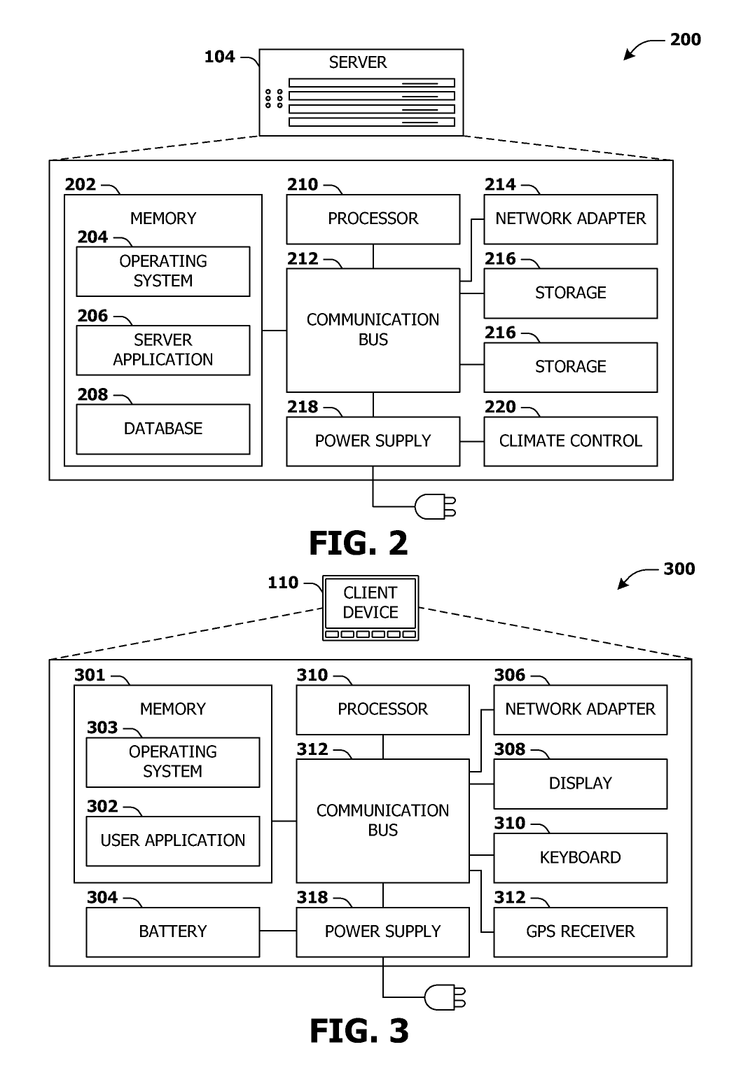

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

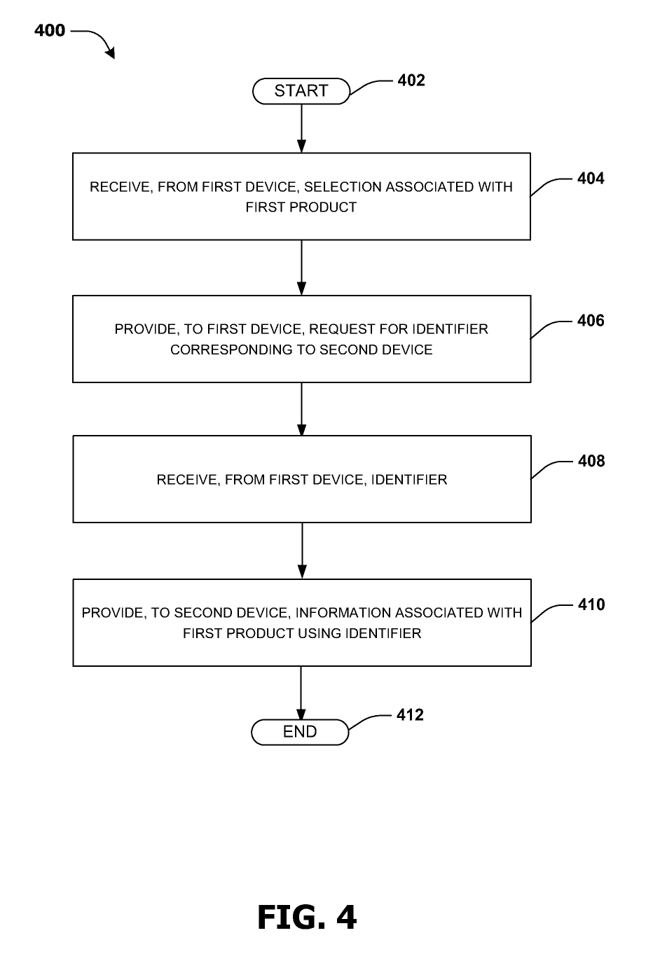

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 210 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 310, a mouse, a microphone, a camera, and/or a touch-sensitive component of the display 308; and/or environmental sensors, such as a global positioning system (GPS) receiver 312 that detects the location, velocity, and/or acceleration of the client device 110, a compass, accelerometer, and/or gyroscope that detects a physical orientation of the client device 110. Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

1. Presented Techniques

One or more systems and/or techniques for providing information associated with a product are provided herein. Responsive to a request from a first device, information associated with a product (e.g., a link for downloading the product) is provided to a second device (e.g., that is different than the first device). The information may be provided to the second device using an identifier of the second device received from the first device. For example, a user of a desktop computer may select (e.g., click on) an advertisement for an application for a mobile device. A request for an identifier (e.g., a phone number) corresponding to the mobile device may be provided to the user (e.g., through the desktop computer). The identifier may be used to provide the mobile device with information associated with the application. The ability to provide the mobile device with the information associated with the application found on the desktop computer may reduce time and/or computing resources otherwise utilized by a user attempting to ascertain the information via the mobile device (e.g., where searching for the information via the mobile device may be more onerous as the mobile device has a smaller user interface, less processing power, slower and/or more expensive (e.g., cellular) connectivity, etc.).

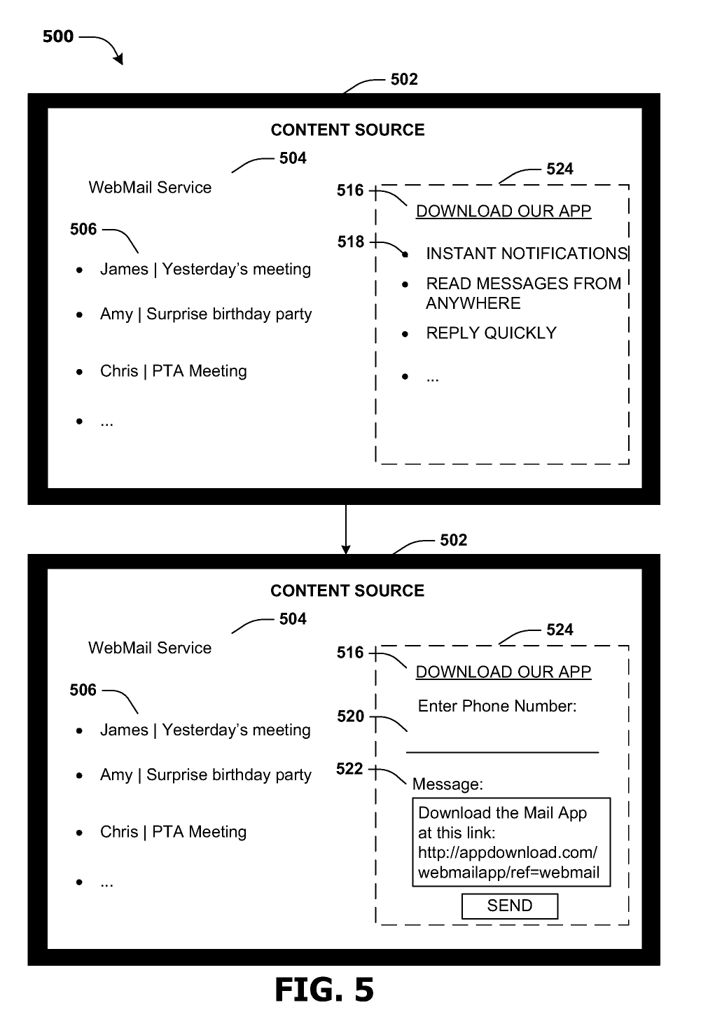

An embodiment of providing information associated with a product is illustrated by an example method 400 of FIG. 4. At 402, the method starts. At 404, a selection associated with a first product may be received from a first device. In an example, a user of the first device may click on a link associated with the first product (e.g., the user may click on an advertisement advertising the first product). The link may, for example, be displayed on a website (e.g., an online email interface). The first product may, for example, comprise an application (e.g., for a mobile device) associated with the website. Alternatively and/or additionally, the first product may comprise an audio file. Alternatively and/or additionally, the first product may comprise a video file. Alternatively and/or additionally, the first product may comprise a document (e.g., an electronic book).

At 406, a request for an identifier corresponding to a second device may be provided to the first device responsive to the receiving a selection at 404. For example, when the user clicks on the link associated with the first product, a request for an identifier corresponding to a mobile device (e.g., a smartphone, tablet, etc.) (e.g., of the user and/or of one or more other users) may be provided to the first device (e.g., from the website). The identifier may comprise a unique identifier that (e.g., merely) corresponds to a second device and/or does not correspond to one or more devices other than the second device. For example, the request may ask for a (e.g., 10 or 11 digit) phone number of the mobile device.

At 408, the identifier may be received from the first device. For example, the user may (e.g., manually) input the phone number via the first device. In another example, the user may select the identifier from a list of one or more identifiers (e.g., corresponding to one or more users). In some examples, the identifier may comprise a name, a username, an email address, etc. In some examples, two or more identifiers corresponding to two or more devices may be received from the first device.

At 410, information associated with the first product may be provided to the second device using the identifier. For example, if the identifier comprises a phone number, information (e.g., a link) associated with the first product may be provided to the second device via a Short Message Service (SMS) message and/or a Multimedia Messaging Service (MMS) message. The information may, for example, comprise a link to a location. The first product and/or more information (e.g., summary, reviews, ratings, etc.) about the first product may be downloadable and/or accessible from the location, for example. For example, if the link is selected via the second device, the first product may (e.g., automatically) be downloaded and/or provided to the second device. In another example, if the link is selected via the second device, a page comprising more information about the first product may be provided to the second device. In the latter example, the first product may be downloaded to the second device responsive to a selection of a link and/or a button on the page. At 412, the method ends.

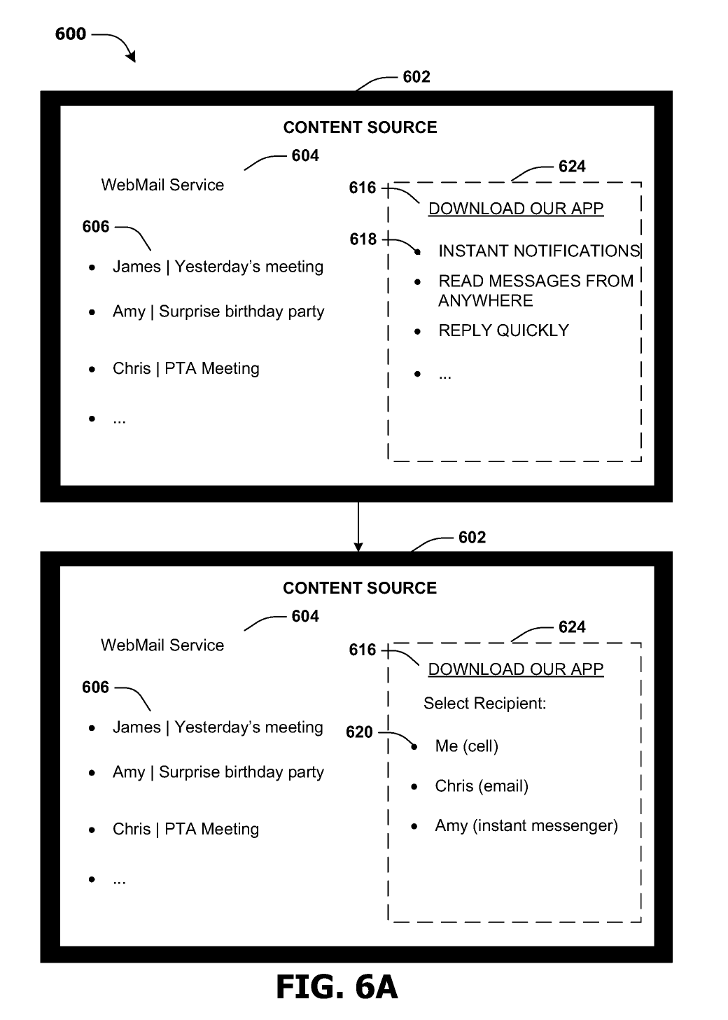

FIG. 5 illustrates an example of a system 500 for providing information associated with a first product. FIG. 5 illustrates a first device that is displaying a content source 502 to a user. The first device may, for example, comprise a computing device. The computing device may comprise a desktop computer, a laptop computer and/or a tablet. The content source 502 may display a website. The website may, for example, provide a (e.g., email) service and/or information (e.g., an article) about the first product. The website may comprise a title 504, content 506 (e.g., summary of one or more emails) and/or an object 524. The object 524 may comprise an advertisement associated with (e.g., for) the first product. The object 524 may comprise a button 516 (e.g., a link) and/or object information 518 (e.g., describing one or more features of the first product).

Responsive to selection of at least some of the object 524, a request 520 for an identifier corresponding to a second device (e.g., different than the first device) may be provided (e.g., as illustrated in the second instance of the content source 502 on the bottom half of FIG. 5). The request 520 may comprise text specifying a type of the identifier and/or an area within which the identifier may be input. In some examples, information associated with the first product may be generated. For example, a message 522 comprising the information may comprise a link to the first product and/or to further information about the first product. In some examples, the message 522 may further comprise one or more words. In some examples, at least some of the message 522 may be created and/or modified by the user, via the first device. The user may provide the identifier (e.g., to a server associated with the website) by inputting the identifier and/or by making a selection (e.g., by clicking on a “send” button) configured to send input data (e.g., to the server). In some examples, responsive to receiving the identifier (e.g., from the first device), at least some of the message 522 may be provided (e.g., sent) to the second device (e.g., by a server). For example, at least some of the message 522 may be provided to the second device via a text (e.g., SMS, MMS, etc.) message, an email message and/or an instant message. In some examples, at least some of the message 522 may be provided to the second device via an application programming interface (API) (e.g., configured to send a text message).

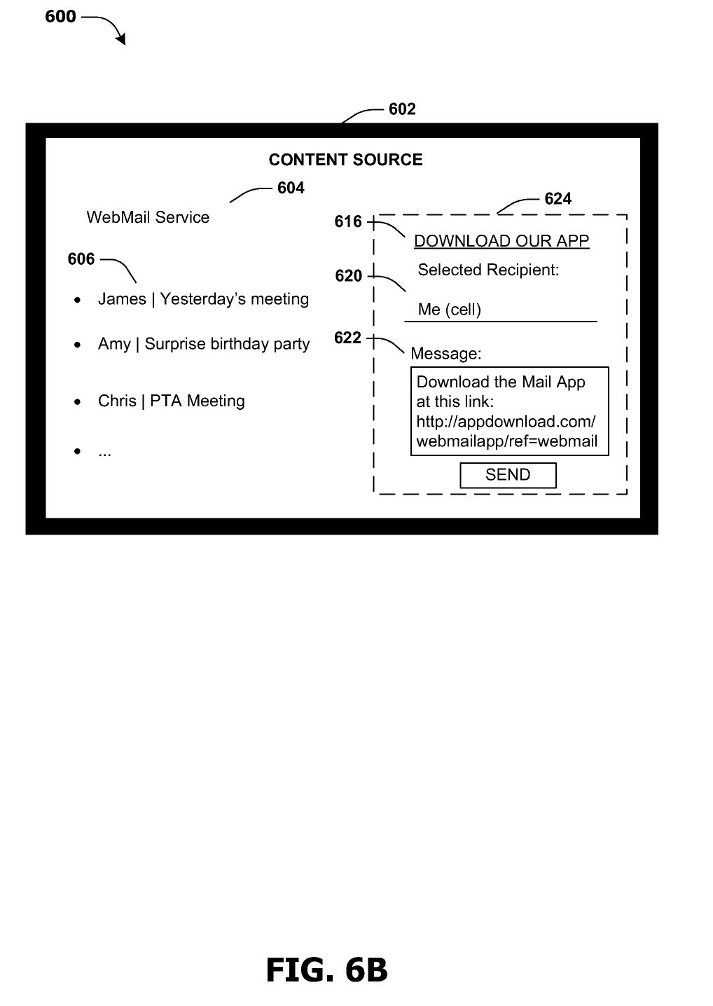

FIG. 6A illustrates an example of a system 600 for providing information associated with a first product. FIG. 6A illustrates a first device that is displaying a content source 602 to a user. The first device may, for example, comprise a computing device. The computing device may comprise a desktop computer, a laptop computer and/or a tablet. The content source 602 may display a website. The website may, for example, provide a (e.g., email) service, and may comprise a title 604, content 606 (e.g., summary of one or more emails) and/or an object 624. The object 624 may comprise an advertisement associated with (e.g., for) the first product. The object 624 may comprise a button 616 (e.g., a link) and/or object information 618 (e.g., describing one or more features of the first product).

Responsive to selection of at least some of the object 624, a request 620 for an identifier corresponding to a second device (e.g., different than the first device) may be provided (e.g., as illustrated in the second instance of the content source 602 on the bottom half of FIG. 6A). The request may comprise a list of one or more identifiers. The one or more identifiers may correspond to one or more users (e.g., the user, contacts (e.g., within a network) of the user, friends of the user, family of the user, etc.). For example, the list may comprise a first identifier (e.g., Me) corresponding to a first user, a second identifier (e.g., Chris) corresponding to a second user and/or a third identifier (e.g., Amy) corresponding to a third user. The respective identifiers may correspond to one or more communication mediums. For example, the first identifier may correspond to a first communication medium (e.g., cell phone and/or text message), the second identifier may correspond to a second communication medium (e.g., email) and/or the third identifier may correspond to a third communication medium (e.g., instant messenger). At least one identifier from the list may be selected. For example, the first identifier may be selected to be the identifier. In some examples, information associated with the first product may be generated. For example, as illustrated in FIG. 6B, a message 622 comprising the information may comprise a link to the first product and/or to further information about the first product. In some examples, the message 622 may further comprise one or more words. In some examples, at least some of the message 622 may be created and/or modified by the user, via the first device. The user may provide the identifier (e.g., to a server associated with the website) by selecting the identifier and/or by making a selection (e.g., by clicking on a “send” button) configured to send input data (e.g., to the server). In some examples, responsive to receiving the identifier, at least some of the message 622 may be provided (e.g., sent) to the second device (e.g., by a server). For example, at least some of the message 622 may be provided to the second device via a text (e.g., SMS, MMS, etc.) message, an email message and/or an instant message. In some examples, at least some of the message 622 may be provided to the second device via an API.

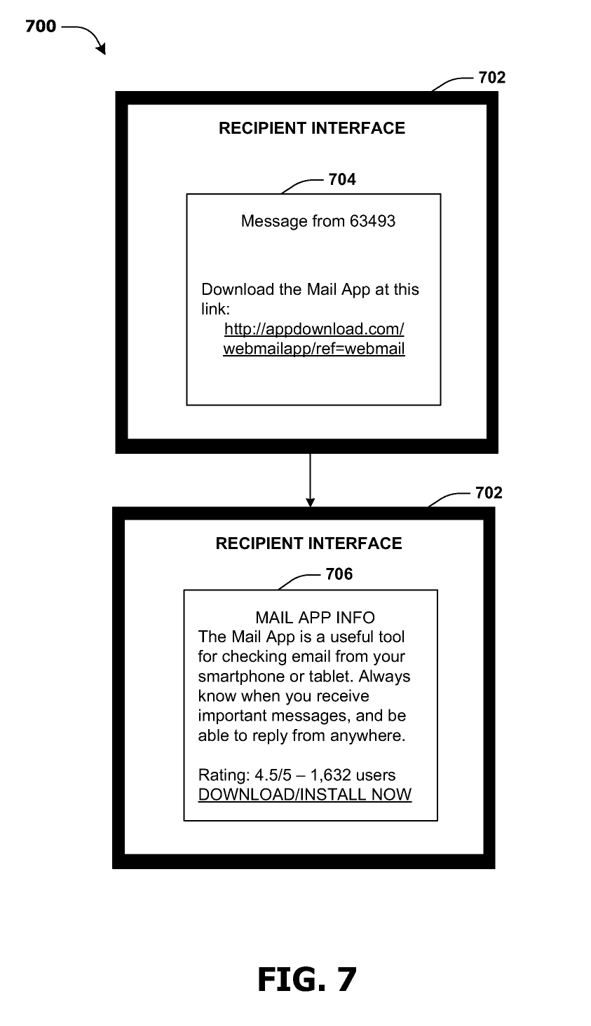

FIG. 7 illustrates an example of a system 700 for providing information associated with a first product. FIG. 7 illustrates a second device that is displaying a recipient interface 702 to a user. The second device may, for example, comprise a mobile device. The mobile device may, for example comprise a smartphone and/or a tablet. The recipient interface 702 may display a message 704. The message 704 may comprise a text message (e.g., an SMS message and/or an MMS message), an email message and/or an instant message (e.g., sent and/or received by an instant messenger). The message 704 may, for example, comprise at least some of the message 622 and/or message 522. For example, the message 704 may comprise a link to the first product and/or to further information about the first product. In some examples, the message 704 may further comprise one or more words.

Responsive to selection of at least some of the message 704, second information 706 may be provided in the recipient interface 702 (e.g., as illustrated in the second instance of the recipient interface 702 on the bottom half of FIG. 7). The recipient interface 702 may display a website comprising the second information 706. In another example, the recipient interface may display a page of a digital distribution platform comprising the second information 706. The digital distribution platform may be associated with the second device. The second information 706 may comprise a name of the first product, a description of the first product, an indication of a number of times the first product has been downloaded and/or installed, an indication of a number of users that downloaded and/or installed the first product, one or more features of the first product, ratings of the first product and/or one or more rankings of the first product. The second information 706 may further comprise a button and/or link that, when selected, may download and/or install the first product (e.g., onto the second device).

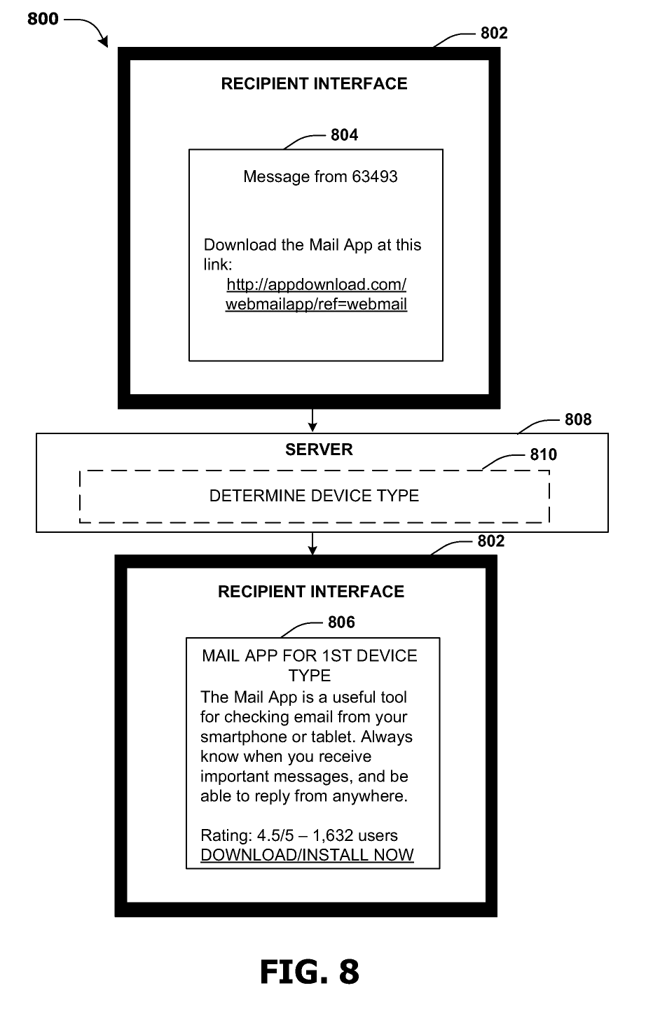

FIG. 8 illustrates an example of a system 800 for providing information associated with a first product. FIG. 8 illustrates a second device that is displaying a recipient interface 802 to a user. The second device may, for example, comprise a mobile device. The mobile device may, for example comprise a smartphone and/or a tablet. The recipient interface 802 may display a message 804. The message 804 may comprise a text message (e.g., an SMS message and/or an MMS message), an email message and/or an instant message (e.g., sent and/or received by an instant messenger). The message 804 may, for example, comprise at least some of the message 622 and/or message 522. For example, the message 804 may comprise a link to the first product and/or to further information about the first product. In some examples, the message 804 may further comprise one or more words.

Responsive to selection of at least some of the message 804, a server 808 may determine 810 a type of the second device. The server 808 may determine 810 the type of the second device based upon a user agent associated with the message 804 and/or the second device. For example, the type may correspond to an operating system associated with (e.g., installed on and/or compatible with) the second device. For example, the server 808 may select one or more operating systems, from a list of operating systems, with which the second device is associated. Alternatively and/or additionally, the type may correspond to a digital distribution platform associated with (e.g., accessible to and/or compatible with) the second device. For example, the server 808 may select one or more digital distribution platforms, from a list of digital distribution platforms, with which the second device is associated.

Based upon the type of the second device, second information 806 may be provided in the recipient interface 802 (e.g., as illustrated in the second instance of the recipient interface 802 on the bottom half of FIG. 8). The recipient interface 802 may display a website comprising the second information 806. In another example, the recipient interface may display a page of a digital distribution platform comprising the second information 806. The digital distribution platform may be associated with the second device. The second information 806 may comprise a name of the first product, a description of the first product, an indication of a number of times the first product has been downloaded and/or installed, an indication of a number of users that downloaded and/or installed the first product, one or more features of the first product, ratings of the first product and/or one or more rankings of the first product. The second information 806 may further comprise a button and/or link that, when selected, may download and/or install the first product (e.g., onto the second device).

A charge (e.g., a fee) may be determined in association with the first product. For example, the charge may be determined for an advertiser of the first product. In some examples, the charge may be determined for the advertiser responsive to the providing of the information (e.g., via text message, instant message, email, etc.) to the second device (e.g., as illustrated by 410 in FIG. 4, 704 in FIG. 7 and/or 804 in FIG. 8). Alternatively and/or additionally, the charge may be determined for the advertiser responsive to receiving a selection associated with the information from the second device (e.g., as illustrated by FIG. 7 and/or FIG. 8). For example, the charge may be determined responsive to a selection of at least some of the message 704 in FIG. 7 and/or the message 804 in FIG. 8. In another example, the charge may be determined responsive to a selection of at least some of the second information 706 in FIG. 7 and/or the second information 806 in FIG. 8. Alternatively and/or additionally, the charge may be determined for the advertiser responsive to receiving an indication that the first product has been at least one of downloaded by or installed on the second device. In some examples, the first device is different than the second device. In other examples, the first device is the same as the second device.

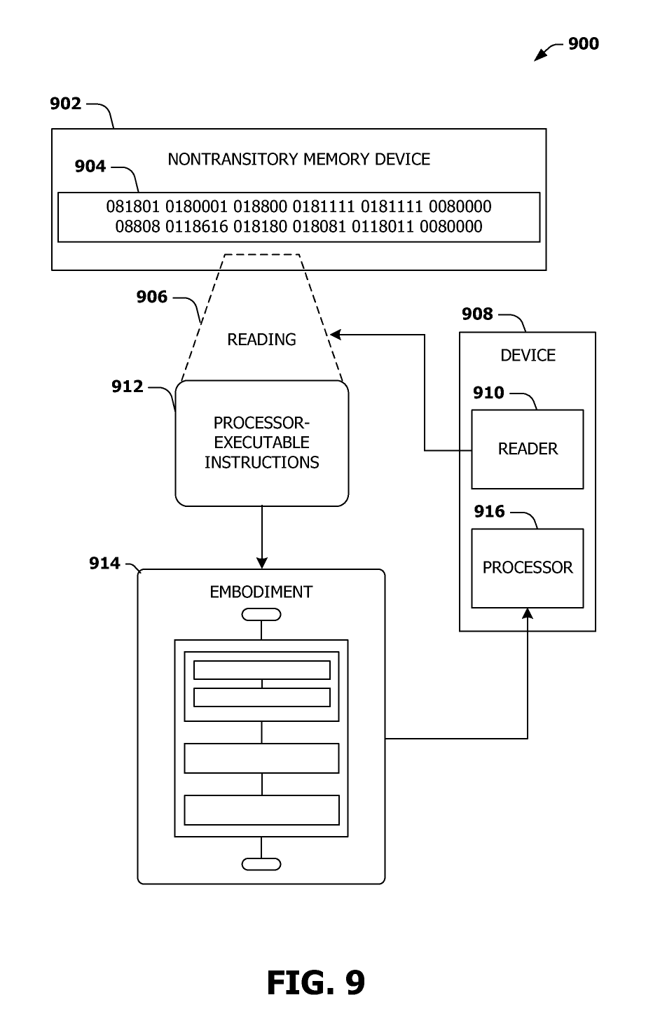

FIG. 9 is an illustration of a scenario 900 involving an example nontransitory memory device 902. The nontransitory memory device 902 may comprise instructions that when executed perform at least some of the provisions herein. The nontransitory memory device may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The example nontransitory memory device 902 stores computer-readable data 904 that, when subjected to reading 906 by a reader 910 of a device 908 (e.g., a read head of a hard disk drive, or a read operation invoked on a solid-state storage device), express processor-executable instructions 912. In some embodiments, the processor-executable instructions, when executed on a processor 916 of the device 908, are configured to perform a method, such as at least some of the example method 400 of FIG. 4, for example. In some embodiments, the processor-executable instructions, when executed on the processor 916 of the device 908, are configured to implement a system, such as at least some of the example system 500 of FIG. 5, at least some of the example system 600 of FIGS. 6A-6B, at least some of the example system 700 of FIG. 7 and/or at least some of the example system 800 of FIG. 8, for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
receiving, from a first device, a selection associated with a first product;
responsive to the receiving a selection, providing, to the first device, a request for an identifier corresponding to a second device, the identifier comprising a phone number;
receiving, from the first device, the identifier; and
providing, to the second device, information associated with the first product using the identifier.

2. The method of claim 1, the providing comprising:
providing the information to the second device via a Short Message Service (SMS) message.

3. The method of claim 1, the providing comprising:
providing the information to the second device via an email message.

4. The method of claim 1, the providing comprising:
providing the information to the second device via a Multimedia Messaging Service (MMS) message.

5. The method of claim 1, the identifier corresponding to merely the second device and not corresponding to one or more other devices.

6. The method of claim 1, the information comprising a link.

7. The method of claim 6, the link corresponding to a location from which the first product is downloadable.

8. The method of claim 1, comprising:
receiving, from the second device, a selection associated with the information; and
responsive to the receiving a selection associated with the information, determining a type of the second device.

9. The method of claim 8, the type corresponding to an operating system associated with the second device.

10. The method of claim 8, the type corresponding to a digital distribution platform associated with the second device.

11. The method of claim 8, comprising:
providing second information to the second device based upon the type of the second device.

12. The method of claim 11, the second information corresponding to a digital distribution platform associated with the second device.

13. The method of claim 1, comprising:
determining a charge for an advertiser associated with the first product responsive to the providing the information to the second device.

14. The method of claim 1, comprising:
determining a charge for an advertiser associated with the first product responsive to receiving, from the second device, a selection associated with the information.

15. The method of claim 1, comprising:
determining a charge for an advertiser associated with the first product responsive to receiving an indication that the first product has been at least one of downloaded by or installed on the second device.

16. The method of claim 1, the providing comprising:
providing the information to the second device via an instant message.

17. The method of claim 1, comprising:
not providing the information to the second device via an instant message.

18. The method of claim 1, the first product comprising at least one of:
an application;
an audio file;
a video file; or
a document.

19. A system, comprising:
a component configured to:
receive, from a first device, a selection associated with a first product;
responsive to receiving the selection, determine an identifier corresponding to a second device; and
provide, to the second device, information associated with the first product using the identifier.

20. A non-transitory computer readable medium comprising computer executable instructions that when executed by a processor perform a method, comprising:
receiving, from a first device, a selection associated with a first product;
responsive to the receiving a selection, providing a request for an identifier corresponding to a second device;
receiving the identifier; and
providing, to the second device, information associated with the first product using the identifier.
